(19) United States
(12) Patent Application Publication
(10) Pub. No.: US 2007/0180704 A1
(43) Pub. Date: Aug. 9, 2007

(54) Locking device for spline shaft of brush cutter

(76) Inventor: Yi-Shan Chiu, Chungli City (TW)

Correspondence Address: RABIN & Berdo, PC, 1101 14TH STREET, NW, SUITE 500, WASHINGTON, DC, 20005, US

(21) Appl. No.: 11/348,381

(22) Filed: Feb. 7, 2006

(51) Int. Cl. B26B 7/00

(52) U.S. Cl. 30/276

(57) ABSTRACT

A locking device for a spline shaft of a brush cutter is disclosed. The brush cutter comprises the spline shaft installed in a shell and coupled with a driven bevel gear that is coupled with a drive bevel gear, which is further linked to a power device. The spline shaft has a blind hole, and the shell has a stub tube facing to the blind hole. A spring and a pin are received in the stub tube in such a way that the pin is inserted through the spring and the spring acts on the pin. With this structure, when a cutting tool is to be assembled to or disassembled from the spline shaft, it is only needed to push the pin into the blind hole of the spline shaft to restrain the spline shaft from rotating. Accordingly, the cutting tool can be assembled or disassembled in safe and convenient.

### BACKGROUND OF THE INVENTION

1. Field of the Invention

The present invention relates to a locking device for a spline shaft of a brush cutter, which has a function of restraining the spline shaft from rotating when a cutting tool is assembled to or disassembling from the brush cutter, thereby being able to greatly improve both security and convenience for operation.

2. The Prior Arts

With reference to FIG. 7, a conventional brush cutter comprises a first shell A and a second shell B that are constructed as an integrated structure. A spline shaft A4 having threads A41 on its lower part is mounted inside the first shell A. An upper end of the spline shaft A4 is inserted through a tooth hole of a driven bevel gear A3 and then fitted in a bearing A2 that is mounted on a top end inside the first shell A. A lower end of the spline shaft A4 is in turn fitted in a bearing A5 and inserted through a liner ring A6, which are then fixed by a retaining ring A7. A cover A8 is installed under the first shell A, and the spline shaft A4 mounts with a collar A9 at its threads A41.

A drive bevel gear B1 is installed in the second shell B. The drive bevel gear B1 has a spindle mounted with two bearings B2, and a liner ring B3 is mounted between the two bearings B2. The two bearings B2 and the liner ring B3 are fixed on the spindle of the drive bevel gear B1 by retaining rings B4, B5. The spindle of the drive bevel gear B1 is connected to an end of a transmission rod (not shown), another end of which is further connected to a power device, such as an engine.

Before the start of the conventional brush cutter, operators need to use a tool, such as a wrench, to disassemble a cutting tool from or assemble to the brush cutter. Due to no any confinements applied on the spline shaft, the spline shaft together with the cutting tool will easily vibrate or rotate during its assembling or disassembling. Accordingly, the operators need to use one hand to securely grab the spline shaft and the other hand to grab the wrench to assemble or disassemble the cutting tool. In this way, it is not only very inconvenient for operation, but also it is very easy to hurt the operators' hands by the cutting tool.

In light of the above-mentioned defect, the present invention intends to have an improvement on the conventional brush cutter.

### SUMMARY OF THE INVENTION

A primary objective of the present invention is to provide a locking device for a spline shaft of a brush cutter, with which a cutting tool can be assembled to or disassembled from the spline shaft in safe and convenient.

To achieve the above-mentioned objective, in accordance with the present invention, a locking device for a spline shaft of a brush cutter is provided. The brush cutter comprises a spline shaft installed in a shell and coupled with a driven bevel gear that is coupled with a drive bevel gear, which is further linked to a power device. The spline shaft has a blind hole, and the shell has a stub tube facing to the blind hole. A spring and a pin are received in the stub tube in such a way that the pin is inserted through the spring and the spring acts on the pin. When pushing the pin into the blind hole of the spline shaft, the pine restrains the spline shaft from rotating, thereby attaining the above mentioned objective.

In order to prevent the spring from bouncing out of the stub tube when releasing the force acting on the pin, the pin is configured with a flange.

Additionally, a cap is mounted with one end of the pin, which extends out of the stub tube, so as to increase pushing area for conveniently pushing operation. The cap can be either constructed as an integrated structure with the pin or just coupled with the pin. For the latter case, the cap has a circular groove for mating with a wall of the stub tube.

A spring pin is mounted to the wall of the stub tube between the flange of the pin and the cap, and the spring pin is able to extend into the stub tube to prevent the pin from bouncing out of the stub tube when releasing the force acting on the pin.

Compared with the conventional brush cutter, the brush cutter in accordance with the present invention has a locking device, so that when a cutting tool is to be assembled to or disassembled from the spline shaft, it is only needed to push the pin into the blind hole of the spline shaft to restrain the spline shaft from rotating. Accordingly, the cutting tool can be assembled or disassembled in safe and convenient.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of a brush cutter in accordance with a preferred embodiment of the present invention;

FIG. 2 is a side view of the brush cutter of the present invention;

FIG. 3 is a cross-sectional view taken along line III-III in FIG. 2, wherein a pin retracts to its original position from a blind hole of a spline shaft of the brush cutter of the present invention;

FIG. 4 is a cross-sectional view showing that the pin is locked into the blind hole of the spline shaft of the brush cutter when a cutting tool is to be assembled to or disassembled from the spline shaft;

FIG. 5 is another cross-sectional view showing that the pin retracts to its original position from the blind hole of the spline shaft of the brush cutter;

FIG. 6 is a perspective view showing that the brush cutter of the present invention couples with a cutting tool; and

FIG. 7 is an exploded view of a brush cutter in accordance with a prior art.

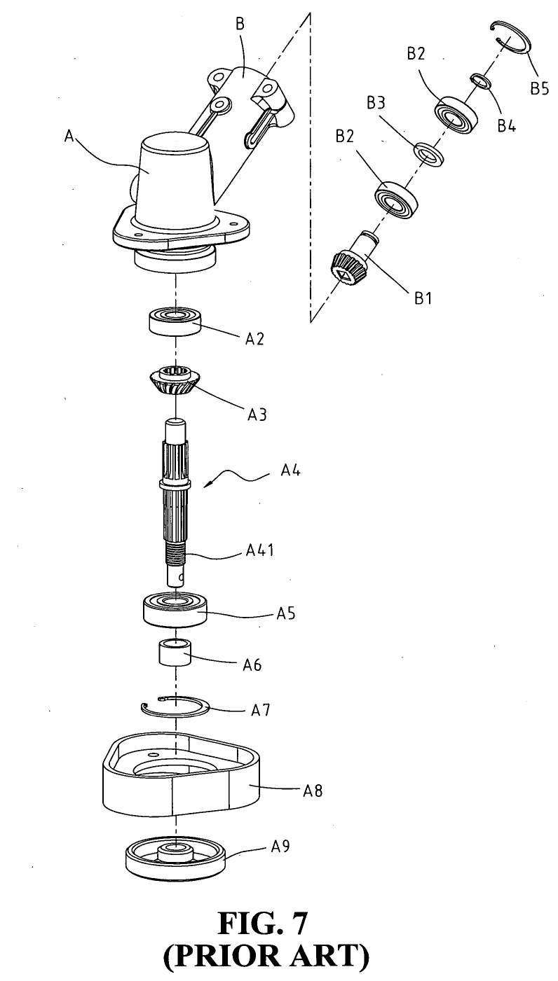

### DETAILED DESCRIPTION OF THE PREFERRED EMBODIMENT

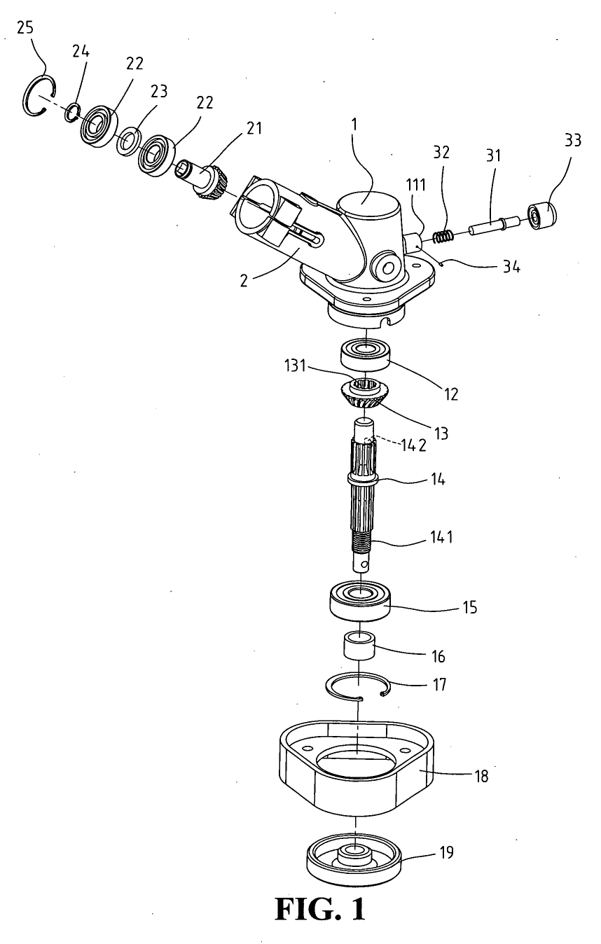

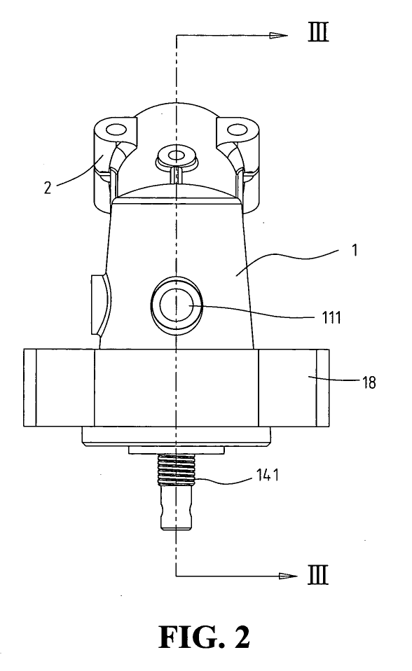

Referring to FIGS. 1-3, a brush cutter in accordance with a preferred embodiment of the present invention comprises a first shell 1 and a second shell 2 that are constructed as an integrated structure. A spline shaft 14 having threads 141 on its lower part is mounted inside the first shell 1. The spline shaft 14 has a blind hole 142 on its spline teeth. An upper end of the spline shaft 14 is inserted through a tooth hole 131 of a driven bevel gear 13 and then fitted in a bearing 12 that is mounted on a top end inside the first shell 1. A lower end of the spline shaft 14 is in turn fitted in a bearing 15 and inserted through a liner ring 16, which are then fixed by a retaining ring 17. A cover 18 is installed under the first shell 1, and the spline shaft 14 mounts with a collar 19 at its threads 141. The first shell 1 has a stub tube 111 facing to the blind hole 142 of the spline shaft 14. A spring 32 and a pin 31 are received in the stub tube 111 in such a way that the pin 31 is inserted through the spring 32 and the spring 32 acts on the pin 31. The pin 31 has a flange 311 for preventing the spring 32 from bouncing out of the stub tube 111. A cap 33 is mounted to one end of the pin 31, which extends out of the stub tube 111. The cap 33 can be either constructed as an integrated structure with the pin 31 or just coupled with the pin 31. For the latter case, the cap 33 has a circular groove 331 for mating with a wall of the stub tube 111. A spring pin 34 is mounted to the wall of stub tube 111 between the flange 311 and the cap 33. The spring pin 34 can be extended into the stub tube 111 to restrain the flange 311, thereby preventing the pin 31 from bouncing out of the stub tube 111.

A drive bevel gear 21 is installed in the second shell 2. The drive bevel gear 21 has a spindle mounted with two bearings 22, and a liner ring 23 is mounted between the two bearings 22. The two bearings 22 and the liner ring 23 are fixed on the spindle of the drive bevel gear 21 by retaining rings 24, 25. The spindle of the drive bevel gear 21 is connected to an end of a transmission rod (not shown), another end of which is further connected to a power device, such as an engine.

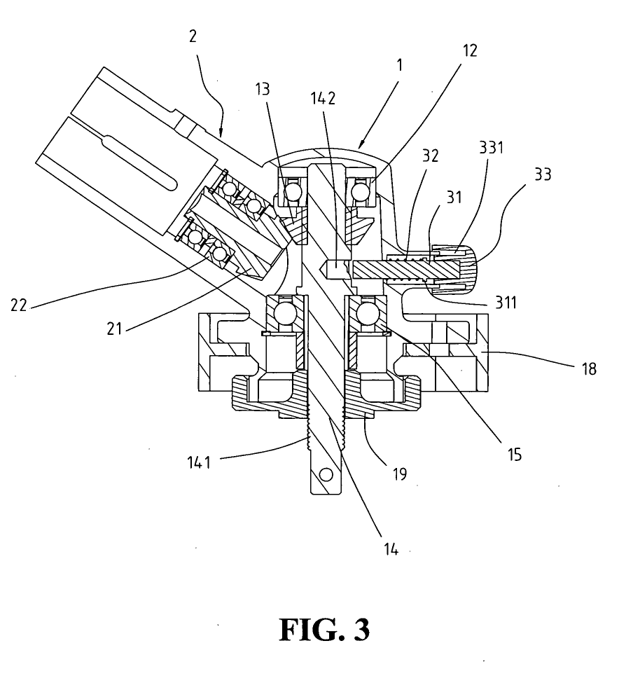

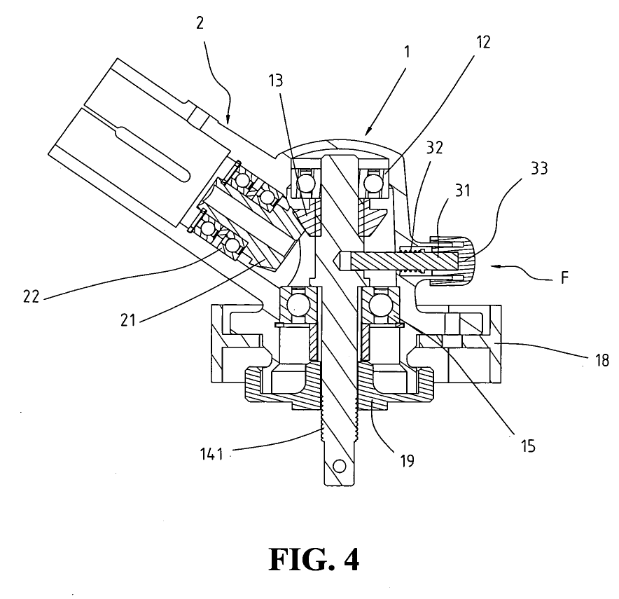

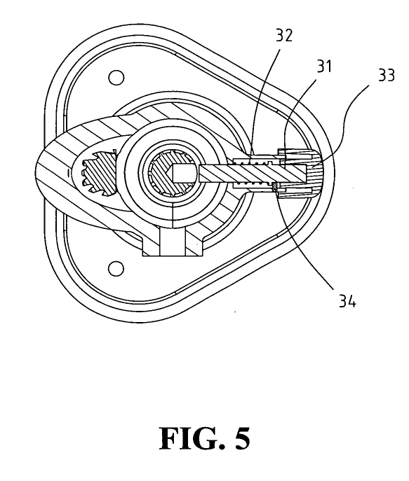

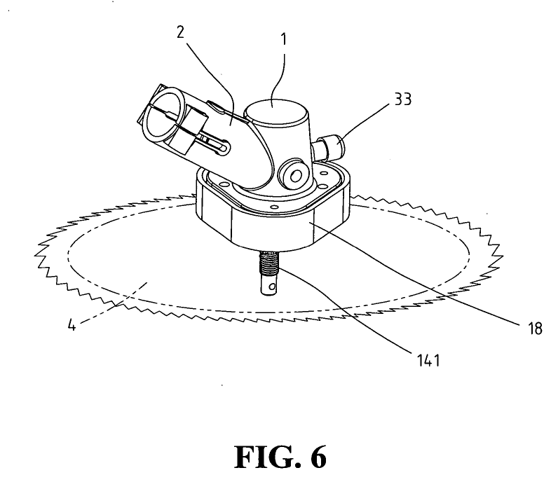

Referring to FIGS. 3-6, when starting the engine, it drives the drive bevel gear 21 and then the coupled driven bevel gear 13 to start rotating. Because the tooth holes 131 of the driven bevel gear 13 engages with spline teeth of the spline shaft 14, the driven bevel gear 13 drives the spline shaft 14 to rotate synchronously, and meanwhile a cutting tool 4 screwed tightly on the spline shaft 14 starts rotating as well. When stopping the power to assemble the cutting tool 4 to or disassemble from the spline shaft 14, it is needed to apply a force F onto the cap 33 for pushing the pin 31 into the blind hole 142 of the spline shaft 14, so as to restrain rotation of the spline shaft 14. In this way, the cutting tool 4 can be securely and conveniently assembled to or disassembled from the spline shaft 14. After releasing the force F, the pin 31 retracts to its original position due to the restoring force of the spring 32, and the pin 31 is not bounced out of the stub tube 111 due to the blockage of the spring pin 34 (see FIG. 5).

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A locking device for a spline shaft of a brush cutter, the brush cutter comprising the spline shaft installed in a shell and coupled with a driven bevel gear that is coupled with a drive bevel gear, which is further linked to a power device, and the improvement comprising:
the spline shaft having a blind hole, the shell having a stub tube facing to the blind hole, a spring and a pin received in the stub tube in such a way that the pin is inserted through the spring and the spring acts on the pin.

2. The locking device as claimed in claim 1, wherein the pin has a flange, and one end of the spring biases against the flange of the pin.

3. The locking device as claimed in claim 2, wherein a cap is mounted with one end of the pin which extends out of the stub tube.

4. The locking device as claimed in claim 3, wherein the cap has a circular groove for mating with a wall of the stub tube.

5. The locking device as claimed in claim 3, wherein a spring pin is mounted to the wall of the stub tube between the flange of the pin and the cap, and the spring pin is able to extend into the stub tube.
